(19) United States
(12) Patent Application Publication
(10) Pub. No.: US 2022/0164741 A1
(43) Pub. Date: May 26, 2022

(54) AUTOMATED BUILDING CONSTRUCTION PROJECT MANAGEMENT SYSTEM

(71) Applicant: SENTERPRISYS Limited, Rocklea (AU)

(72) Inventors: Lev Mizikovsky, Brisbane (AU); Mike Fennell, Brisbane (AU)

(21) Appl. No.: 17/430,836

(22) PCT Filed: Jun. 13, 2019
(86) PCT No.: PCT/AU2019/050610

§ 371 Date: Aug. 13, 2021

(30) Foreign Application Priority Data
Feb. 14, 2019 (AU) 2019100163

(51) Int. Cl. G06Q 10/06

(52) U.S. Cl. CPC G06Q 10/06313

(57) ABSTRACT

The present invention relates to an automated building construction project management system. The system includes a data receiver for receiving project data relating to a project. A processor processes the received project data. The system also includes an action generator for automatically generating actions based upon the processed data. Advantageously, the processor may include a multitude of processing modules relating to various aspects of the project, thereby enabling the system to provide automatically generated actions that represent a clear overall picture of the project. The system of the preferred embodiment provides for a reduction in management of up to 95% and a reduction in office staff of up to 75% when administering building construction projects. Furthermore, the inherent errors associated with project management are substantially reduced.

### TECHNICAL FIELD

The present invention generally relates to an automated building construction project management system, having particular application to estimating job costs, ordering products and managing resources.

The invention also has particular application to digitized and automated systems providing integrated quality assurance control in construction projects.

### BACKGROUND

The reference to any prior art in this specification is not, and should not be taken as an acknowledgement or any form of suggestion that the prior art forms part of the common general knowledge.

The project management of building construction is an involved task. Often, the delay in one tradesman or product supply can undesirably delay the whole project.

In practice, project managers use various software systems to assist them in managing the project to avoid such delays. However, in practice, delays are still incurred through the project manager not having a clear overall picture of the project.

The preferred embodiment provides an improved building construction project management system.

Estimating the cost of a construction job, in a new locale and in order to submit a winning bid that will still be profitable is difficult. If a general contractor is unfamiliar with the unique materials required by local zoning codes, it can inadvertently result in the purchase of materials which are unsuitable for the project.

If material errors are not caught until work is nearly completed, the losses rapidly mount up as rework is required. In addition, aside from the wrong material needing to be replaced, the whole project can be held up further when ordering the correct material significantly adding to losses.

Currently, hundreds of different items, handled by different distributors, are often required for a single project. Many telephone calls and weeks are required to compile prices for estimation and bidding on a project.

The preferred embodiment provides a system for automating the price estimation of a construction job. Further, the preferred embodiment provides an automated system for purchasing goods and services in the job location factoring in local variations. Furthermore, the preferred embodiment provides an automated system for tracking the use of goods and services.

Project managers of building construction jobs typically use spreadsheets, databases, and other software tools in order to track the information they need to run their jobs. Much of that information is accumulated in manual file folders and logs. In addition, many middle managers are required to run a project, which is complex, and it is very difficult for the managers to coordinate effectively without introducing errors.

Advantageously, the preferred embodiment provides a system for reducing middle management and errors during project management of the building construction job.

### SUMMARY OF THE INVENTION

According to one aspect of the present invention, there is provided an automated building construction project management system including:

a data receiver for receiving project data relating to a project;

a processor for processing the received project data; and

an action generator for automatically generating actions based upon the processed data.

Advantageously, the processor may include a multitude of processing modules relating to various aspects of the project, thereby enabling the system to provide automatically generated actions that represent a clear overall picture of the project.

The system of the preferred embodiment provides for a reduction in management of up to 95% and a reduction in office staff of up to 75% when administering building construction projects. Furthermore, the inherent errors associated with project management are substantially reduced.

The processor may include artificial intelligence. The processor may overlay design rules actioned by the artificial intelligence. The artificial intelligence may include machine learning capable of learning by effectively memorizing prior solutions for previous projects and incorporating them into project management functions for the project. Advantageously, estimates, scheduling, management and administration of the project may be automatically amended without human intervention

The system may be configured to generate a cost estimate using computer aided design (CAD) data for the project. The generated cost estimate may be further determined using any one or more of location, local statutory requirements (town planning) or specification data.

The system may be configured to generate a project schedule for the project. The system may be configured to administer the project schedule using critical path algorithms, task durations and/or predecessor task links. The system may determine tasks due now, tasks which are overdue, task scheduled dates compared with the original baseline schedule dates and the number of days the project remains unfinished.

The system may be configured to communicate with customers, suppliers and/or consultants.

The system may be configured to generate site-specific preliminary orders for the project using identify specification and/or location data.

The system may be configured to create contract documents using CRM data and the generated cost estimate.

The processor may include integrated processing modules including one or more of: a customer management module; an estimating and ordering module; a contract and compliance module; a project management module; a bookkeeping and WIP (Work in Progress) module and a business reports module.

According to another aspect of the present invention, there is provided an automated building construction project management method involving:

receiving project data relating to a project;

processing the received project data; and

automatically generating actions based upon the processed data.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic view of a processor for a building construction project management system, with an artificial intelligence (Al) processor, in accordance with an embodiment of the present invention;

FIG. 2 is a schematic view of a customer management module of the processor of FIG. 1;

FIG. 3 is a schematic view of an estimating and ordering module of the processor of FIG. 1;

FIG. 4 is a schematic view of a contract and compliance module of the processor of FIG. 1;

FIG. 5 is a schematic view of a project management module of the processor of FIG. 1;

FIG. 6 is a schematic view of a bookkeeping and WIP module of the processor of FIG. 1; and

FIG. 7 is a schematic view of a business reports module of the processor of FIG. 1;

FIG. 8 is a schematic view of a communications module of the processor of FIG. 1;

FIG. 9 is a schematic view of a document library module of the processor of FIG. 1;

FIG. 10a-10k is a block diagram showing the process flow between each of the modules, indicating module interaction, what data is needed and what manual work is automated, using the processor of FIG. 1;

FIG. 11a-11g is a block diagram showing the process flow between each of the modules, indicating device hardware and software technologies used, using the processor of FIG. 1; and

FIG. 12a-12k are block diagrams showing the material properties used in estimating and the various actions rules and triggers applied.

### DETAILED DESCRIPTION OF PREFERRED EMBODIMENTS

### System Overview

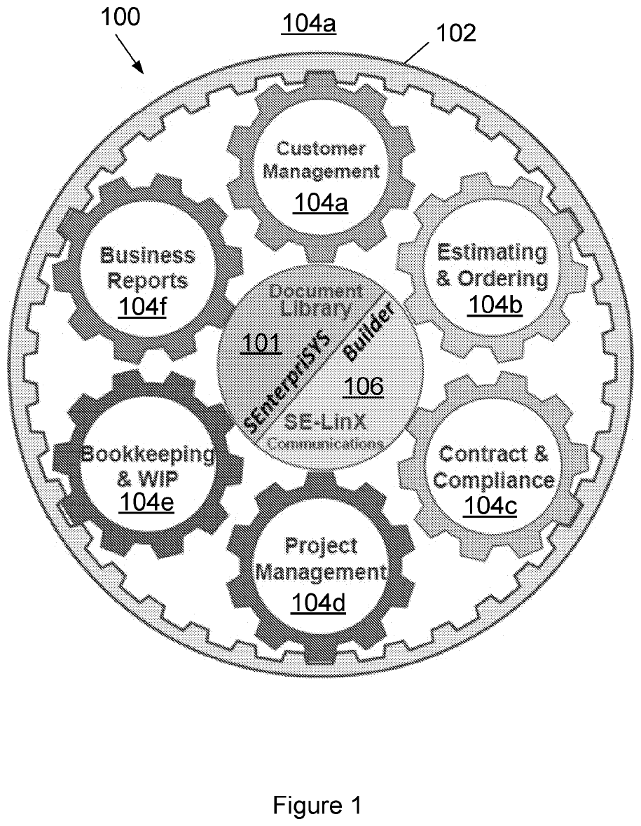

According to an embodiment of the present invention, there is provided an automated building construction project management system 100 as shown in FIG. 1.

The system 100 includes a data receiver, including a document library module 101, for receiving project data relating to a project. An artificial intelligence (Al) processor 102 is provided for processing the received project data. The system 100 further includes an action generator which automatically generating actions and the deadlines based upon the processed data. The action generator includes a display for displaying the action deadlines to the project manager.

Advantageously, the processor 102 includes a multitude of processing modules 104 relating to various aspects of the project, thereby enabling the system 100 to provide automatically generated actions that represent a clear overall picture of the project. The modules 104 are all in communication with each other using a communications module 106. The Al processor 102 overlays design rules actioned using artificial intelligence.

The system 100 automates appointments, reminders, license checks, distribution of safety, plan and WMS (Work Method Statements), job orders, customer job updates, scheduling & updating, follow up on trades and suppliers, and warranty and maintenance.

The system 100 provides an integrated technical solution to: automate trenches of rules-based work; schedule key business processes by making decisions on when to automatically instruct staff, subcontractors and/or suppliers to take subsequent steps; enforce business rules; reflect specific project requirements and processes; and compensate for loss of flexibility by speed and cost gains and redirection in efforts. The system 100 provides an ecosystem and a platform for sharing information and linking customers, builders, subcontractors, consultants and suppliers in an orderly efficient and coordinated manner through the processing modules 104 described below.

Customer Management Module 104a

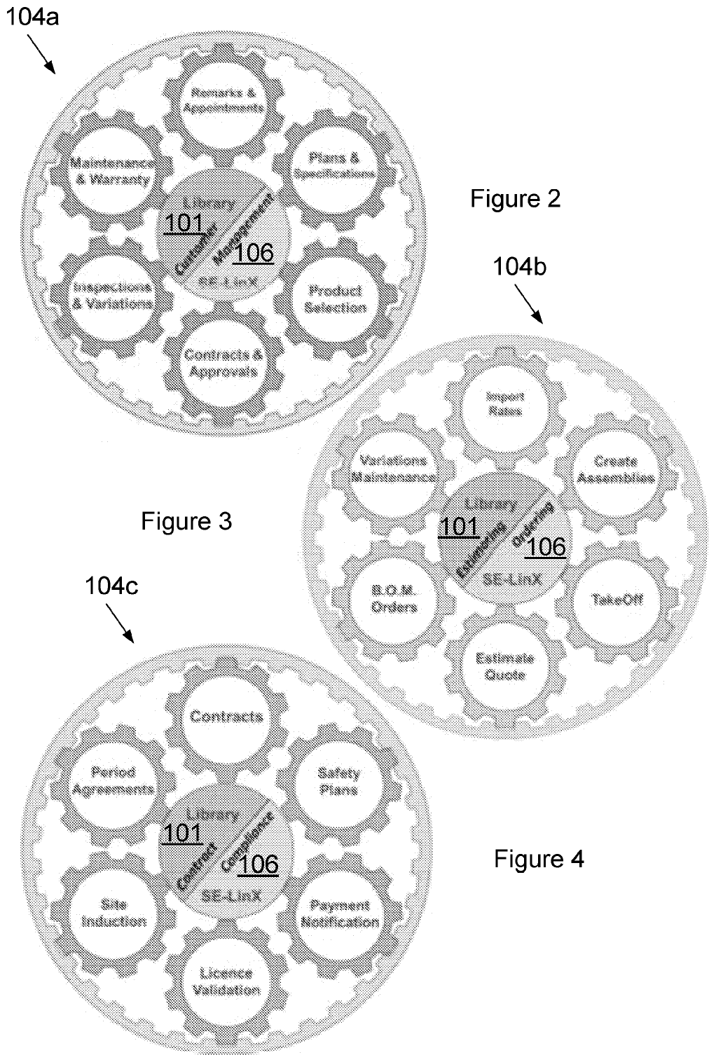

The customer management module 104a of FIG. 2 automates a number of front and back office processes as well as enforces minimum documentation requirements. Using SELinx communications module 106, the customer management module 104a provides customers with required documentation and Logs customer interactions as well as providing data needed to merge into documents.

Estimating and Ordering Module 104b

The estimating and ordering module 104b of FIG. 3 automates measuring, estimating and ordering. The module 104b is capable of using PDF's, CAD generated Bills of Quantities, and manual measurements. A multistage recipe system combines provisional cost items from various components ready for customer selection. The rules-based quote to estimate system ensures orderly customisation process. A project management linked order process reduces potential for unapproved payments. The module 104b scales and assigns measure units, and displays components already measured.

Contract and Compliance Module 104c

The contract and compliance module 104c of FIG. 4 ensures compliance with workplace health and safety (WHS), contractual requirements, payment rules and more. The rules based module 104c demands approval of critical documents. The module 104c also distributes latest documents, safety instructions and directs work flows in order of priority.

Project Management Module 104d

The project management module 104d of FIG. 5 undertakes the bulk of processing of the system 100. The module 104d combines data from most other modules 104 to issue instructions to: execute automated tasks; update task lists and overdue reports; provides data needed to calculate WIP; schedule inspections; generate progress claims; approve payments and issue payment plans.

Bookkeeping and WIP Module 104e

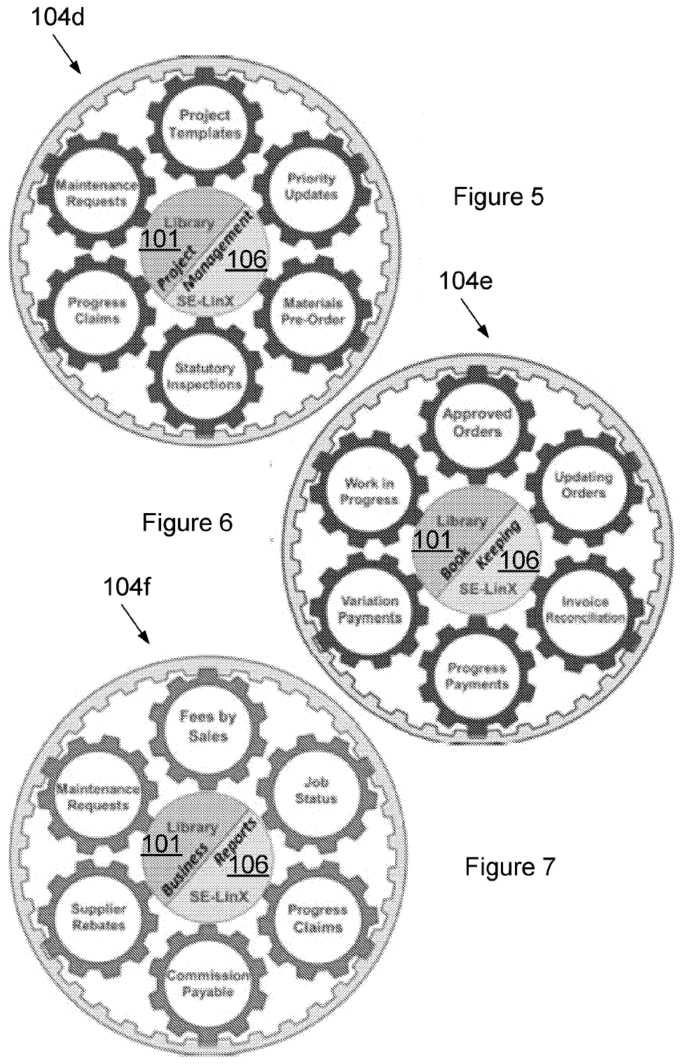

The bookkeeping and WIP module 104e of FIG. 6 is configured to: display orders ready for payment and outstanding orders; produce payment plans; record invoices and payments; record received progress payments and list outstanding payments; request and record variation claims and payments; and supply financial information needed to produce WIP reports.

Business Reports Module 104f

The business reports module 104f of FIG. 7 is equipped with a number of essential reports covering most stages of the sales and construction process, accounts payable and receivable, insurance payments, and cost overruns. A report generator is provided to allow users to build custom reports as needed.

Document Library Module 101

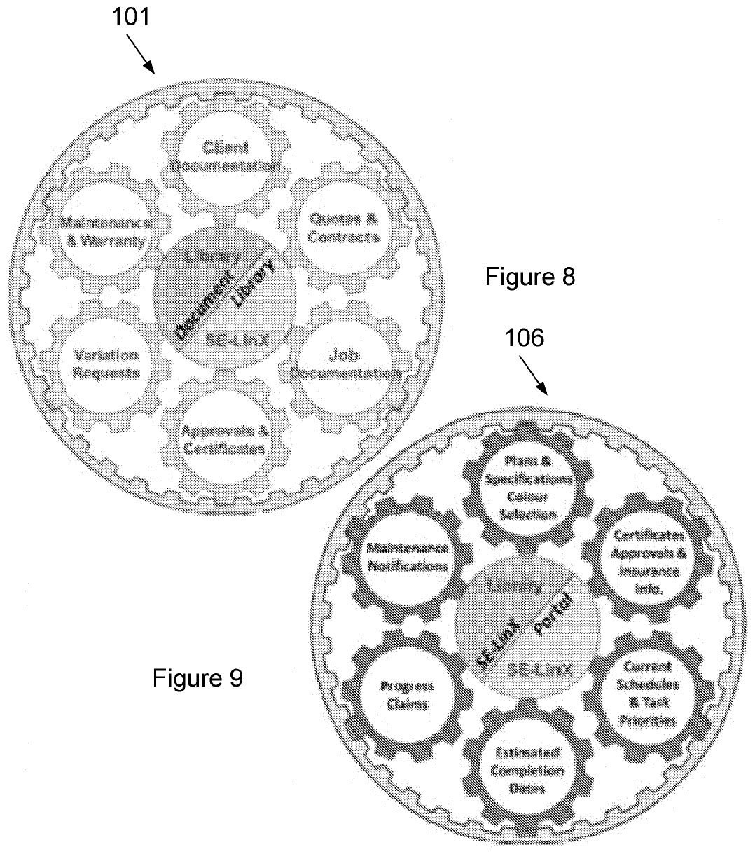

The document library module 101 of FIG. 8 Document Library is configured so that: the latest document in a set is displayed first; it is possible to find mis-saved documents using numbers and letters strings; it has a business rules-based component requiring a certain critical document to be saved to allow job to progress to the next stage; and it controls access to specific documents and automatically shares documents with predetermined parties.

Communications Module 106

The SE-Linx communications module 106 of FIG. 9 is a web-based communication module linking all stakeholders and is configured to: distribute instructions from the project management module 104d; requesting progress claims supply relevant documentation; distributing up to date contract documentation; notify estimated task completion dates; automatically transfer documents to the document library module 101; and connect stakeholders to the project management module 104d.

The system 100 provides integrated online access for merging of a variety of compliance documents.

A person skilled in the art will appreciate that many embodiments and variations can be made without departing from the ambit of the present invention.

Small Business

The system 100 can be used by a variety of small businesses to automate appointments, reminders, job orders, customer job updates, task scheduling, follow up on trades and suppliers, and warranty and maintenance.

Quality Assurance System

The system 100 can be adapted to effectively implement a quality assurance system to provide users with a set of modules 104 and tools allowing for multilevel information distribution.

Hardware & Software

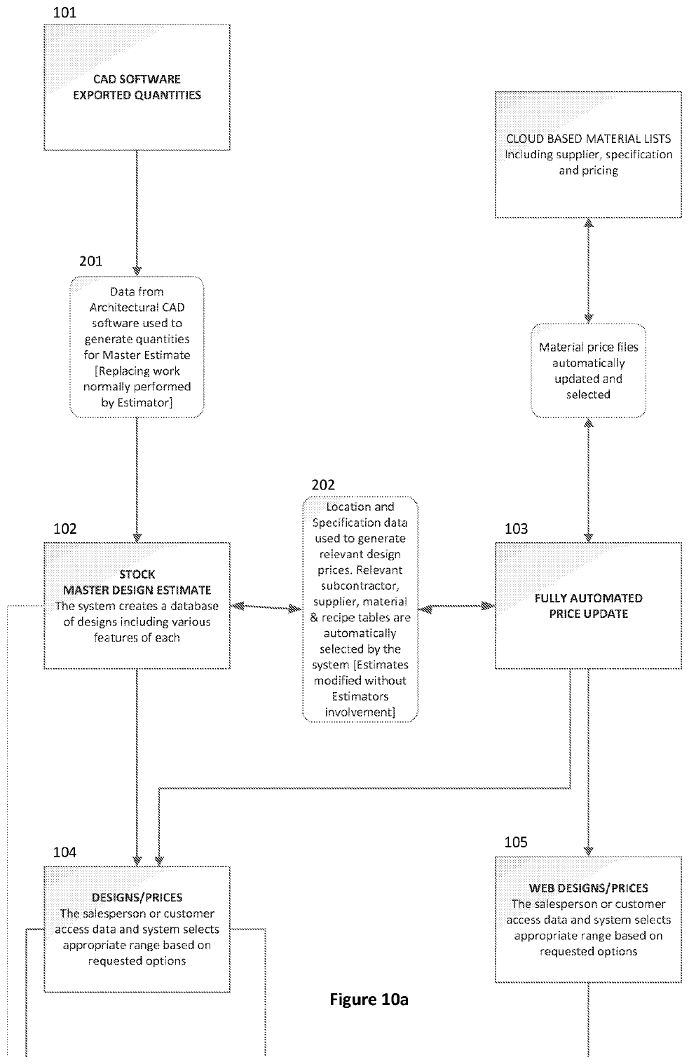

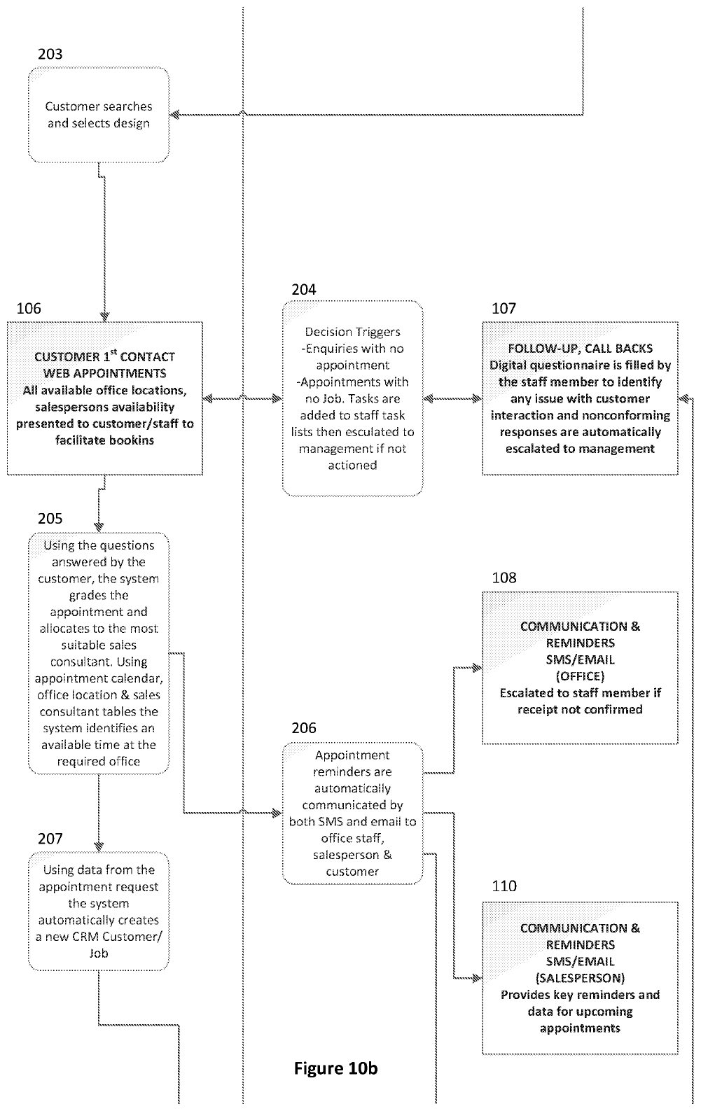

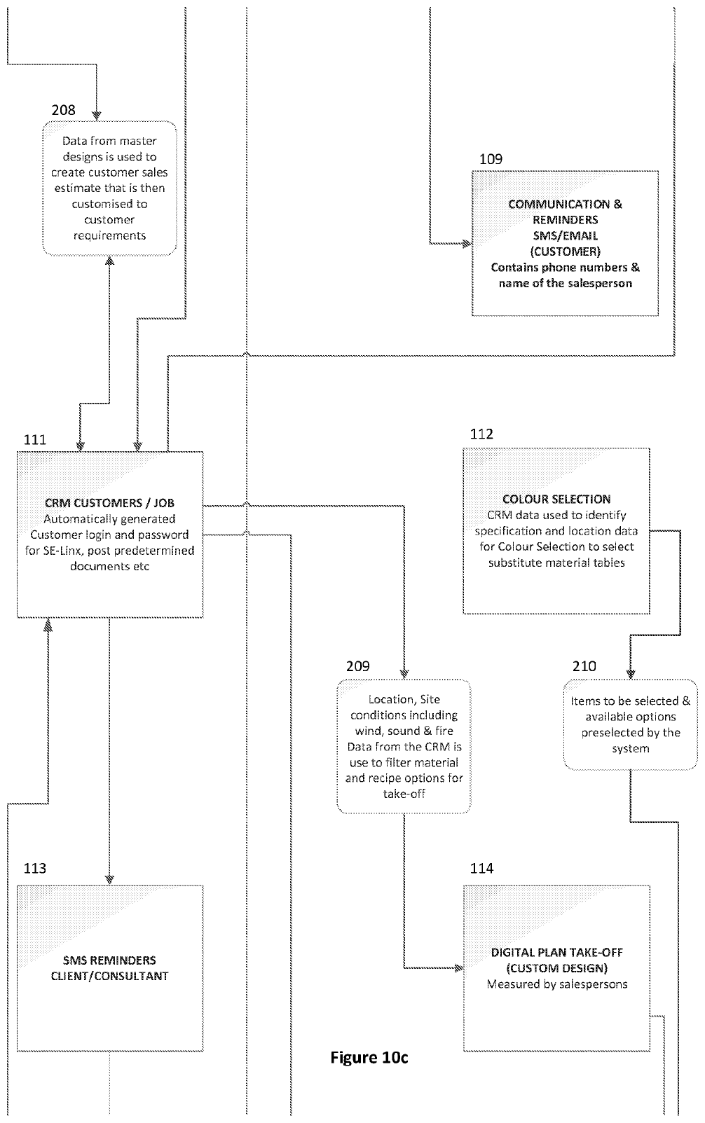

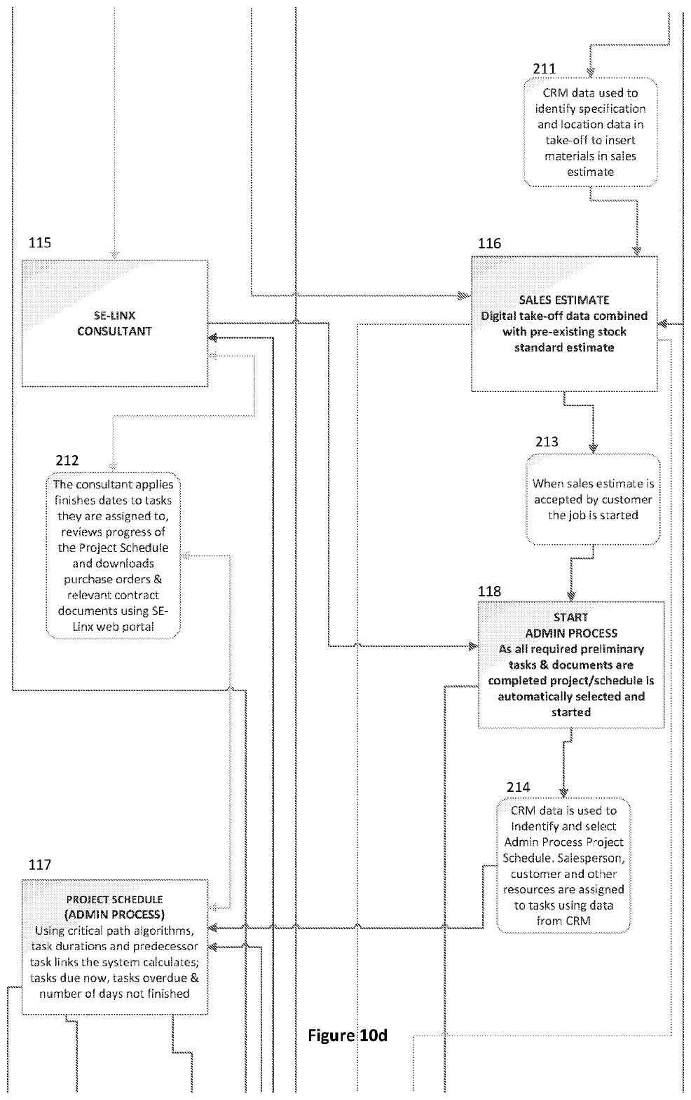

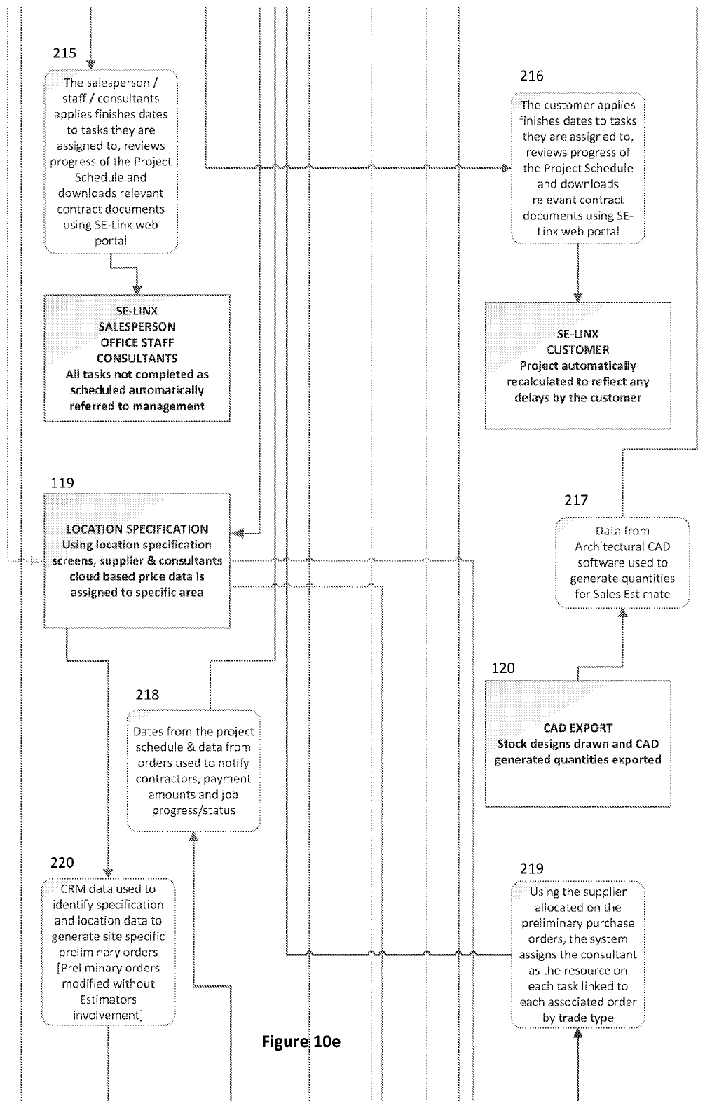

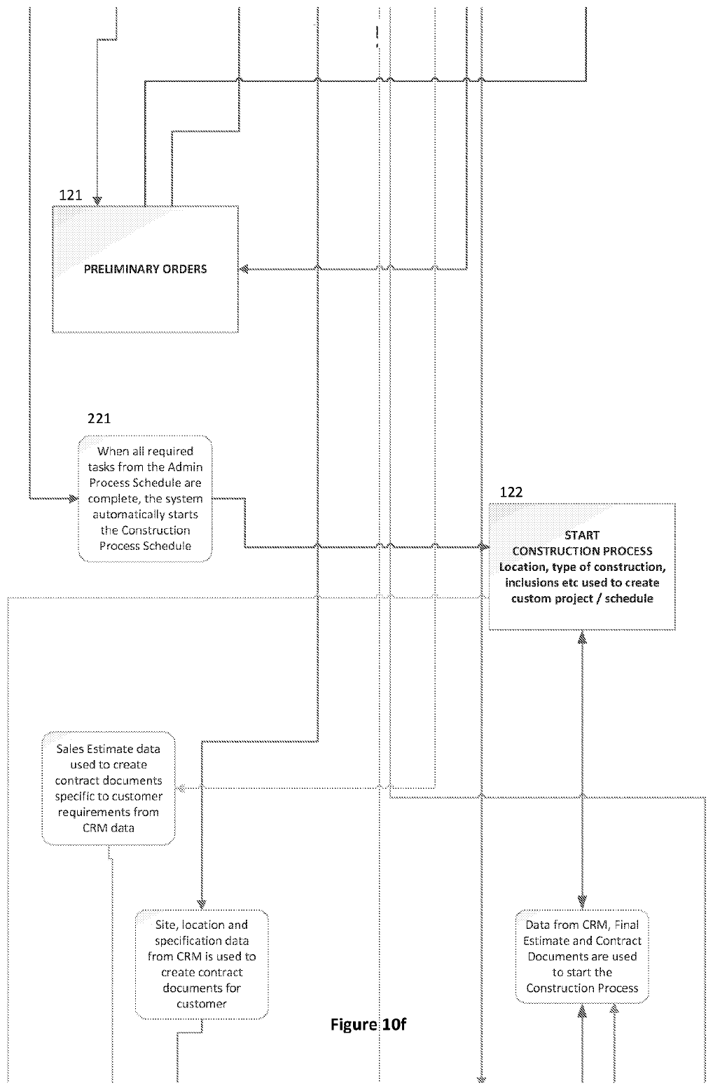

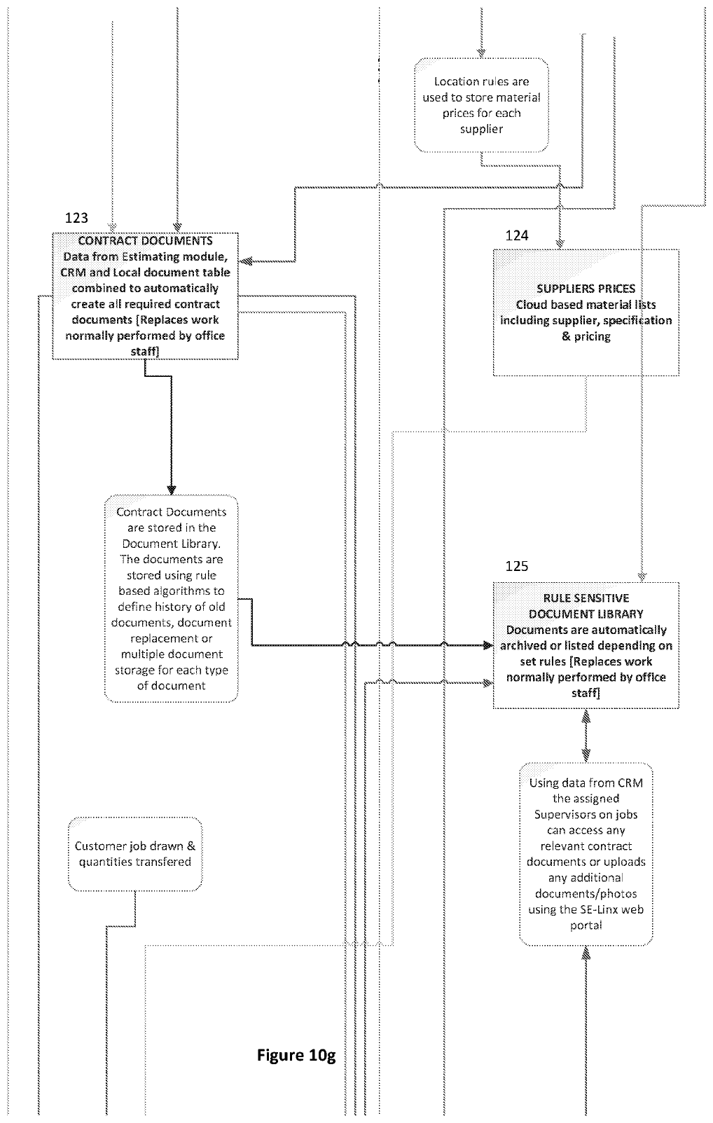

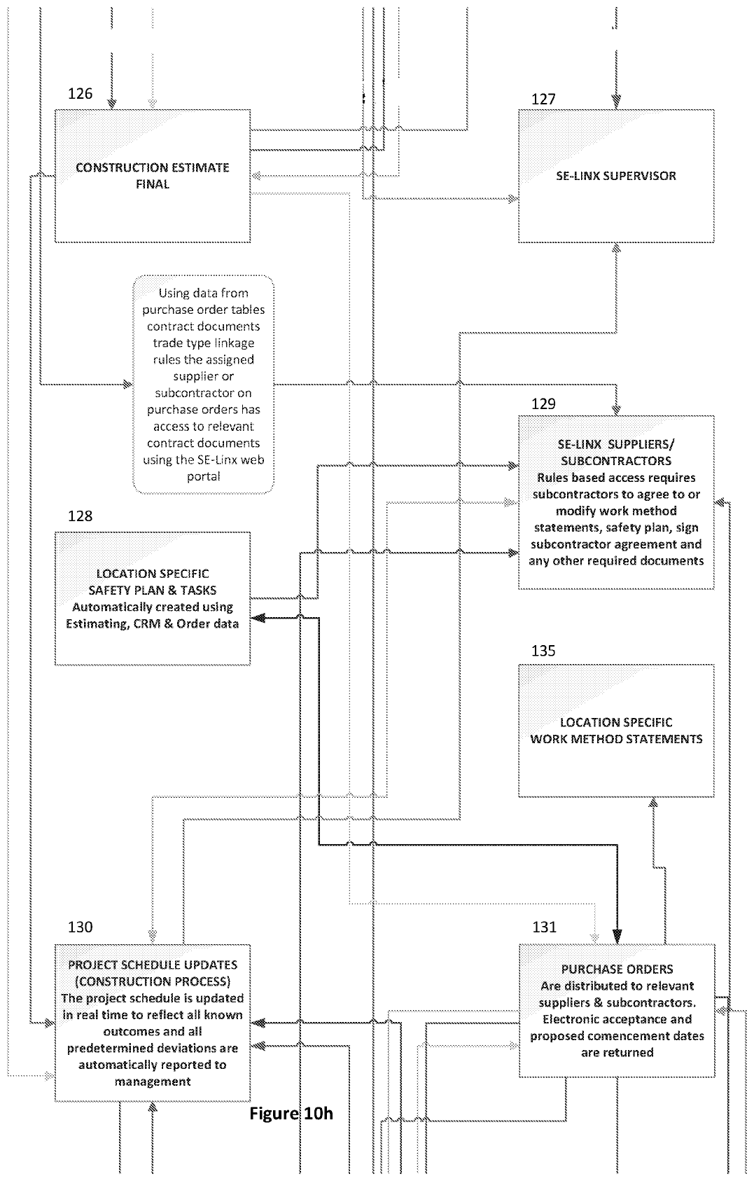

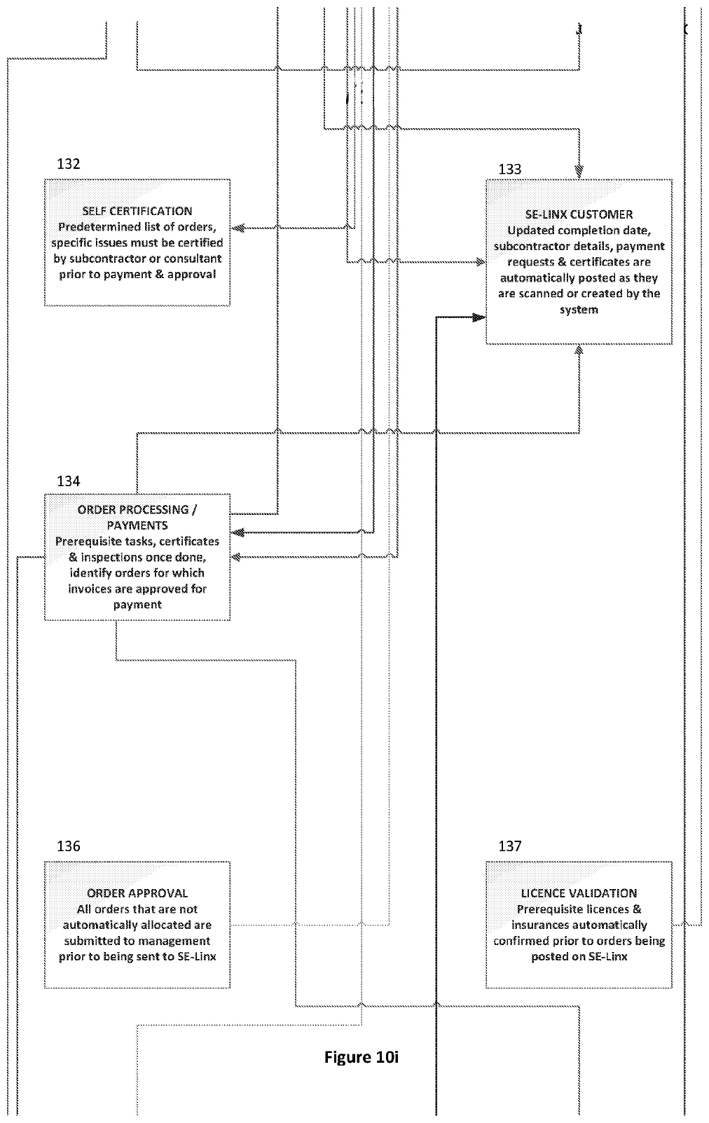

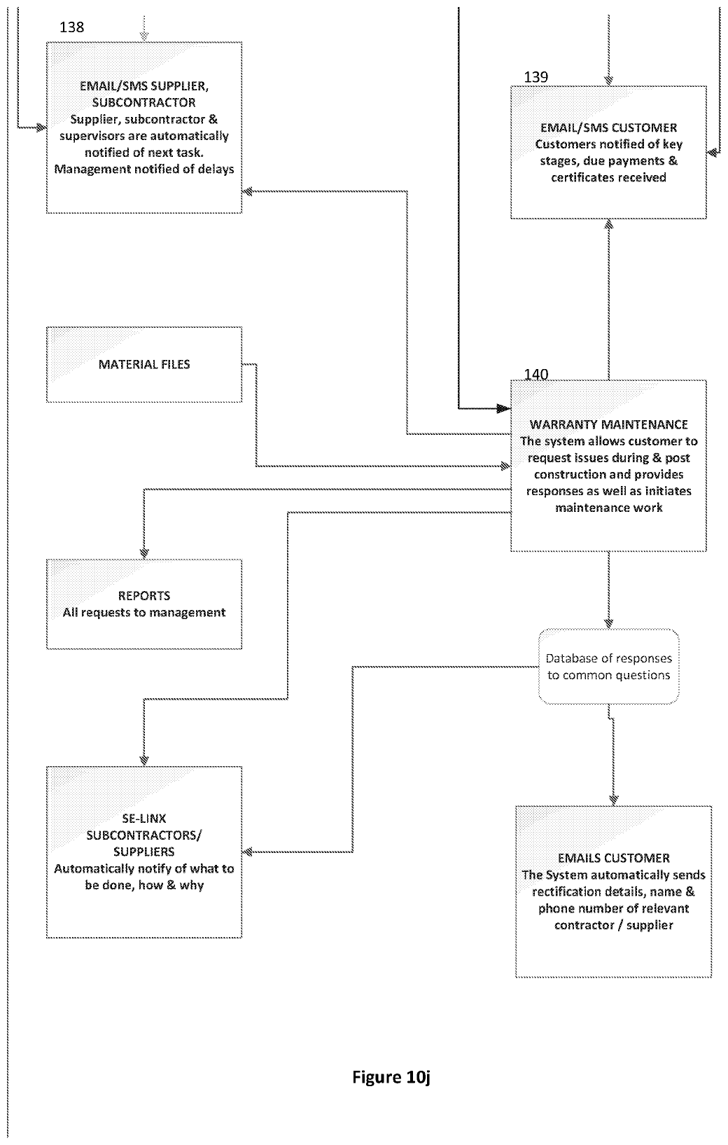

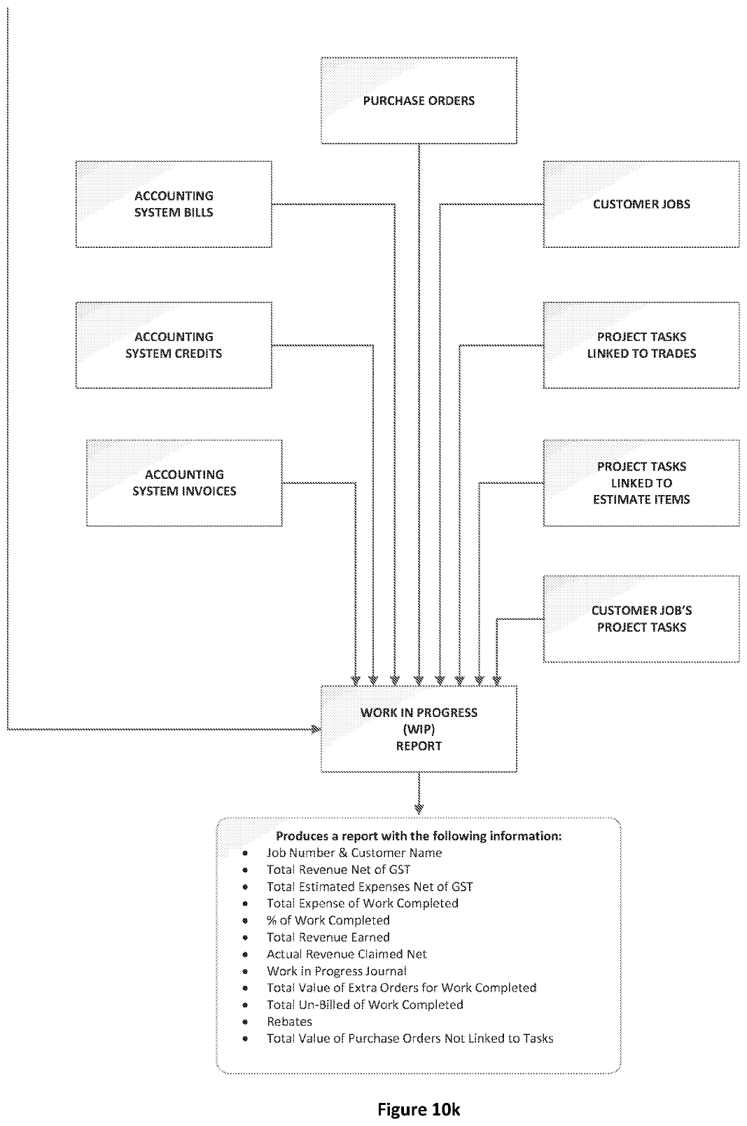

FIG. 10a-10k shows the process flow between each of the modules performed using the system 100. The modules are depicted with pointed process boxes and reference numerals with a prefix of “1”, whereas the description of how each of the modules interact with each other, what data is needed, what manual work by humans has been replace by this invention, is depicted with rounded process boxes and reference numerals with a prefix of “2

At Block 10-101, CAD software quantities for the construction job are exported.

At Block 10-201, data from architectural CAD software is used to generate quantities for a master estimate.

At Block 10-102, the master design estimate is provided.

At Block 10-202, the system 100 uses the location and specification data to generate relevant design prices. Relevant sub contractor, supplier, material and recipe tables are automatically selected by the system 100.

At Block 10-103, a construction update is provided.

At Block 10-104, designs and prices are provided.

At Block 10-105, web designs and prices are provided.

At Block 10-203, the system 100 enables customers to search and select designs.

At Block 10-106, the customer inputs data and makes appointments via the Internet.

At Block 10-204, decision triggers are generated by the system 100. Enquiries with no appointment and appointments with no job are identified. Tasks are added to staff task lists and then elevated to management if not actioned.

At block 10-107, follow-up and callbacks to customers are provided.

At Block 10-205, the system 100 uses input by the customer to grade the appointment and allocate the most suitable sales consultant. Using an employment calendar, and office location and sales consultant tables, the system 100 automatically identifies an available time at the required office.

At Block 10-206, appointment reminders are automatically communicated by both SMS and email to office staff, sales people and the customer.

At Block 108, the communication and reminders are sent via SMS and email to the office.

At Block 10-207, the system 100 uses data from the appointment request to automatically create a new CRM customer entry and job.

At Block 10-110, communication and reminders are sent via SMS and email to a salesperson.

At Block 10-208, the system 100 processes data from master designs to create a customer sales estimate. The customer sales estimate is then customised to customer requirements.

At Block 10-109, communication and reminders are sent via SMS and email to the customer.

At Block 10-111, a CRM customer and job is created.

At Block 10-112, the construction colour selection is provided.

At Block 10-209, the location, site conditions (e.g. wind, sound and fire), and data from the CRM is used to filter material and recipe options for take-off or launch.

At Block 10-210, the CRM data is used to identify specification and location data in colour selection to substitute materials.

At Block 10-113, SMS reminders are sent to the client and consultant.

At Block 10-114, the digital construction plan is launched in accordance with the customised design.

At Block 10-211, the CRM is used to identify specification and location data in take-off to insert materials in the sales estimate.

At Block 10-115, a consultant is provided for the construction program.

At Block 10-116, a sales estimate is provided for the construction project.

At Block 10-212, the consultant applies finish dates to tasks they are assigned to, reviews the progress of the project schedule and downloads purchase orders and relevant contract documents using a web portal.

At Block 10-213, when a sales estimate is accepted by the customer, the construction job is started.

At Block 10-118, the administration process associated with the construction is started.

At Block 10-214, CRM data is used to identify and select an administration process project schedule. Salesperson, customer and other resources are assigned to tasks using data from the CRM.

At Block 10-117, the project schedule is administered using critical path algorithms, task durations and predecessor task links. The system calculates tasks due now, tasks are overdue and the number of days not finished. All activities identified as critical are subject to controls and any changes are required to be approved and published by a designated manager.

At Block 10-215, the salesperson applies any finish dates to tasks, reviews project progress of the project schedule and downloads relevant contract documents using the Internet web portal.

At Block 10-216, the customer also applies any finishes dates to tasks, reviews progress of the project schedule and downloads relevant contract documents using the web portal.

At Block 10-119, the location specification is provided.

At Block 10-217, data from architectural CAD software is used to generate quantities for sales estimate.

At Block 10-218, dates from the project schedule and data from preliminary orders are used to notify contractors, and determine payment amounts and job progress/status.

At Block 10-120, CAD software exported quantities are provided.

At Block 10-220, CRM data is used to identify specification and location data to generate site-specific preliminary orders.

At Block 10-219, the system 100 uses the supplier allocated on the preliminary purchase orders and assigns the consultant as the resource on each task linked to each associated order by trade type.

At Block 10-121, the preliminary orders are provided.

At Block 10-221, when all required tasks from the administration process schedule are complete, the system 100 automatically starts the construction process schedule.

At Block 10-122, the construction process is started. Sales estimate data is used to create contract documents. CRM data is used to create contract documents. Data from CRM, final estimate and contract documents are used to start construction process.

At Block 10-123, contract documents are provided.

At Block 10-124, supplier prices are provided.

At Block 10-103, price updates are provided.

At Block 10-125, a rule sensitive document library is provided.

At Block 10-126, the construction estimate is made final.

At Block 10-127, a supervisor for the construction project is provided.

At Block 10-128, a location specific safety plan is provided.

At Block 10-129, suppliers and contractors are provided.

At Block 10-130, project schedule for the construction process is provided.

At Block 10-131, purchase orders are generated.

At Block 10-132, self certification is provided.

At Block 10-133, the customer is provided.

At Block 10-134, order or processing and payments are provided.

At Block 10-135, location specific work method statements are provided.

At Block 10-136, order approval is provided.

At Block 10-137, license validation is provided.

At Block 10-138, email and SMS confirmations are provide to the supplier and subcontractor.

At Block 10-139 emails and SMSs are provided to the customer.

At Block 10-140, warranty maintenance is provided.

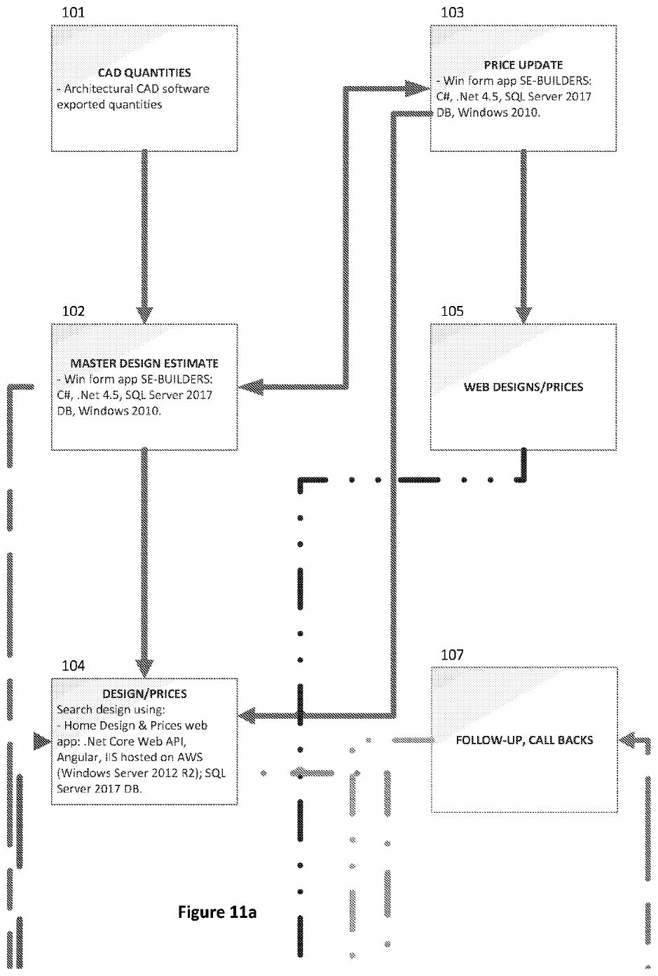

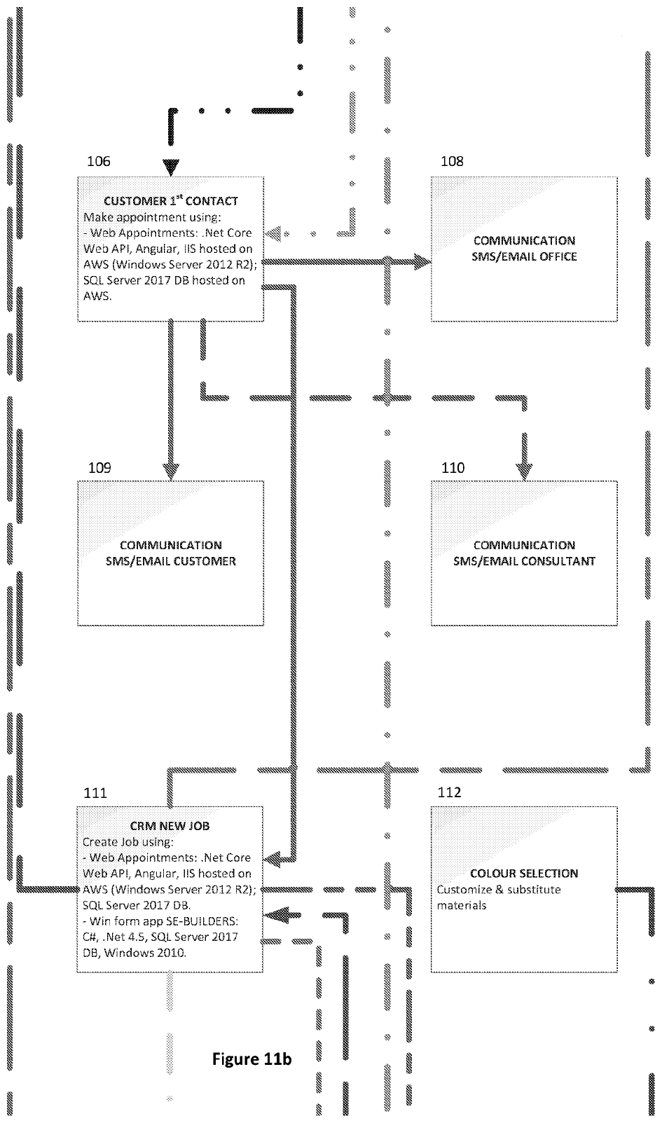

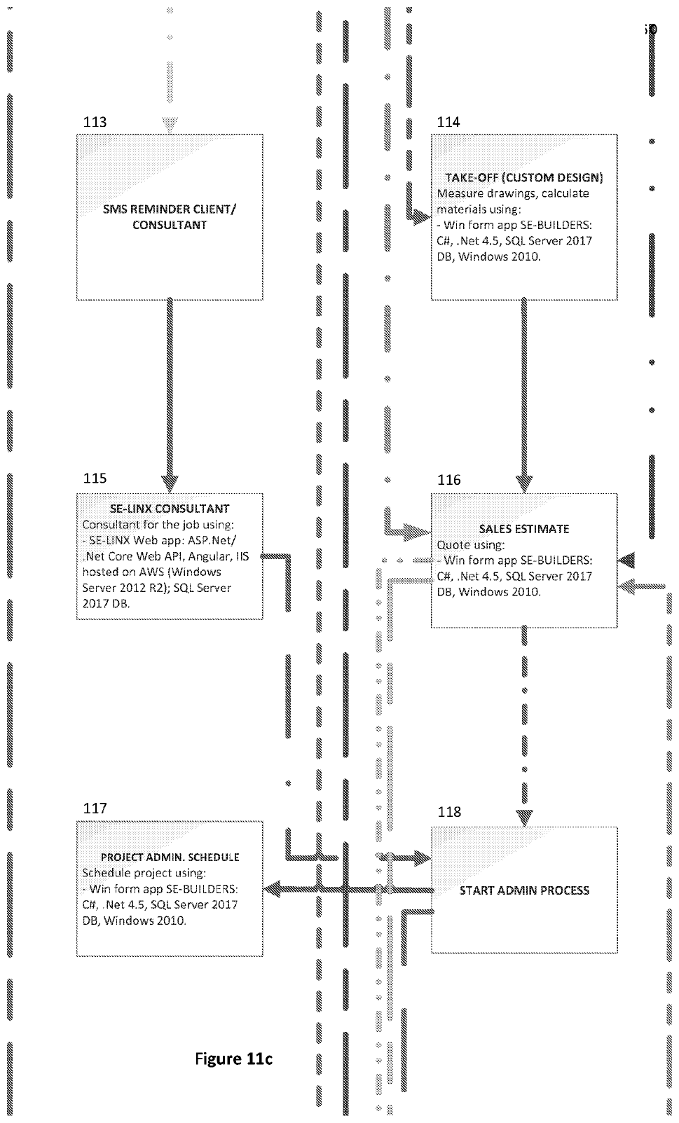

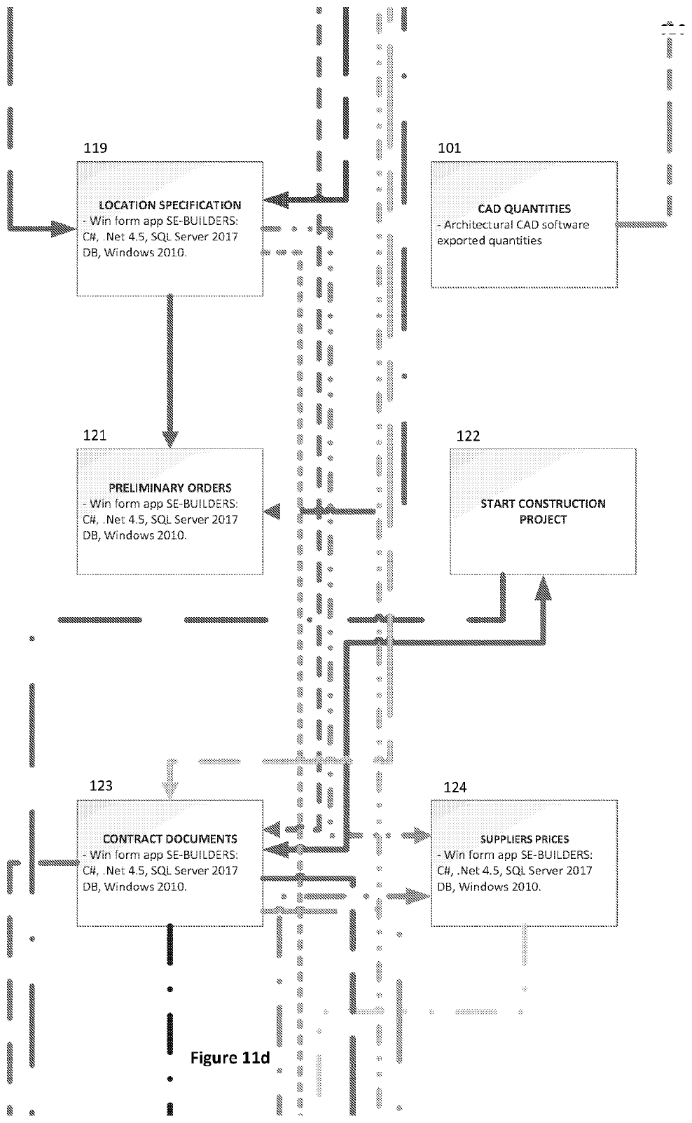

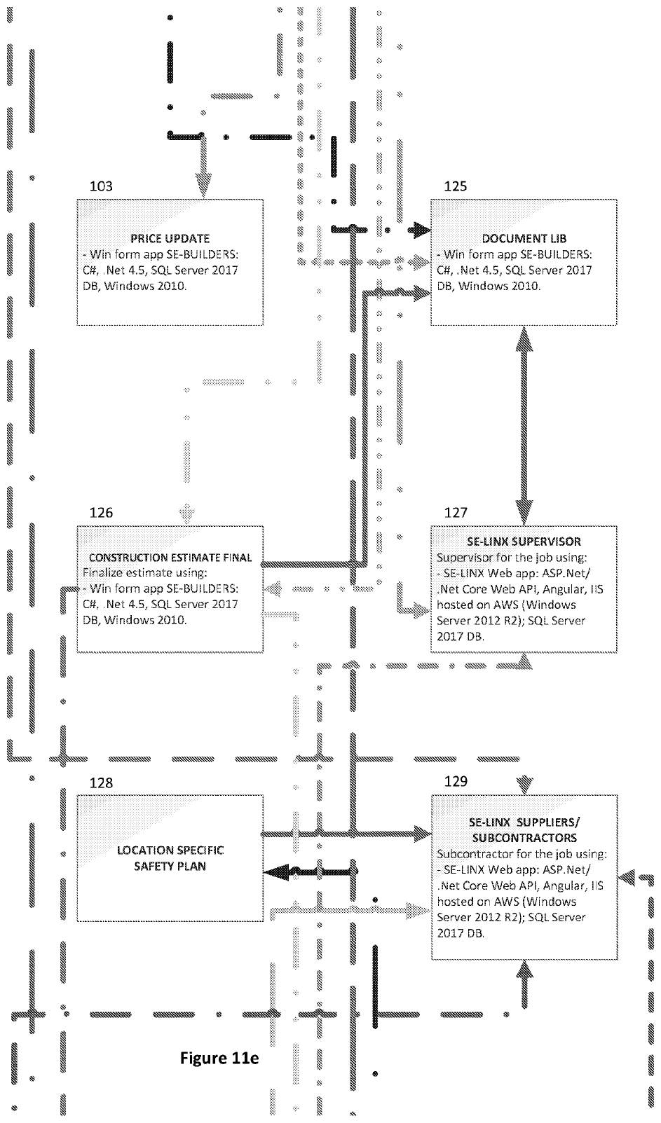

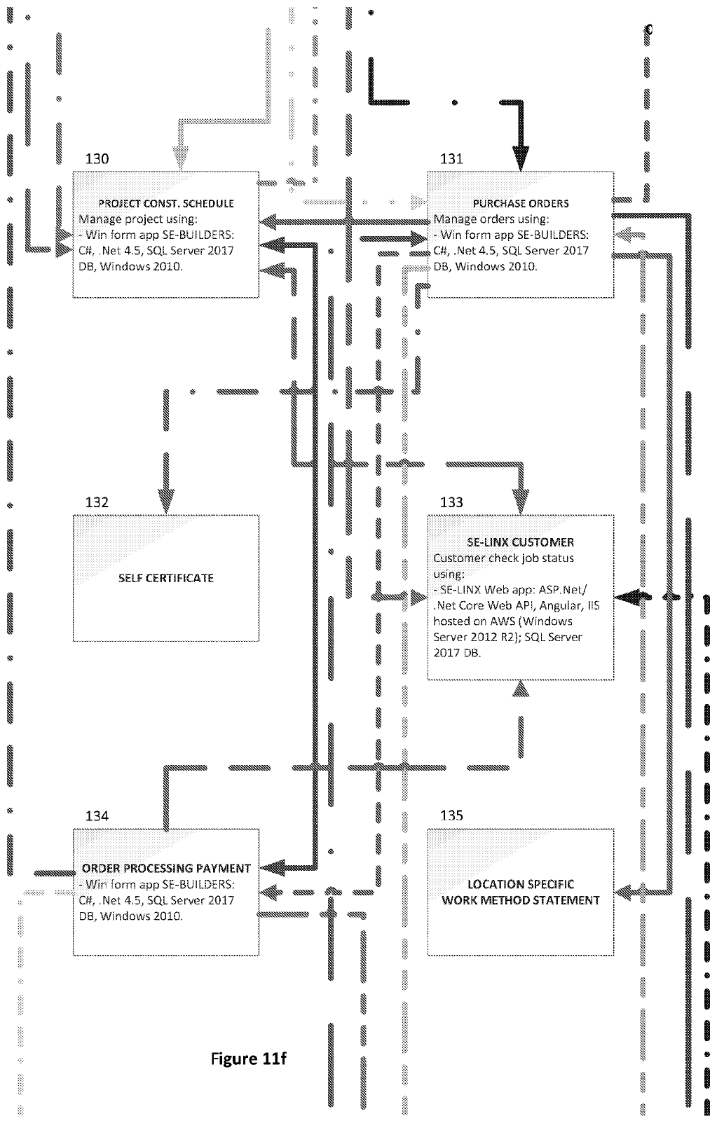

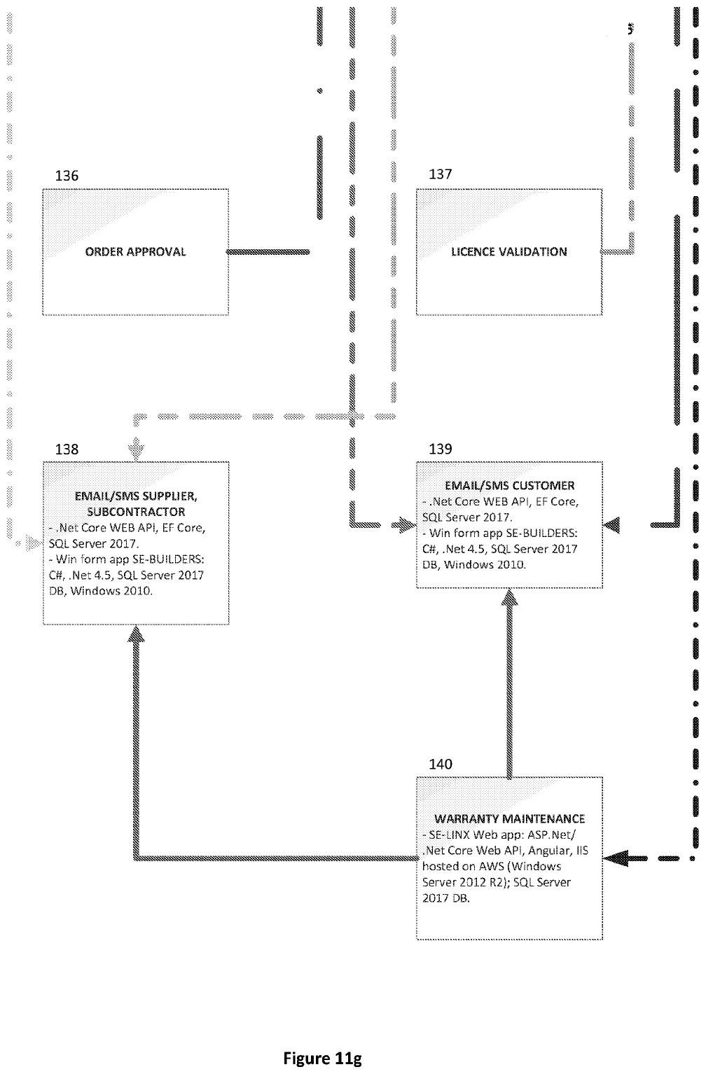

FIG. 11a-11g is a block diagram showing the process flow between each of the modules, indicating device hardware and software technologies used, using the processor of FIG. 1; and

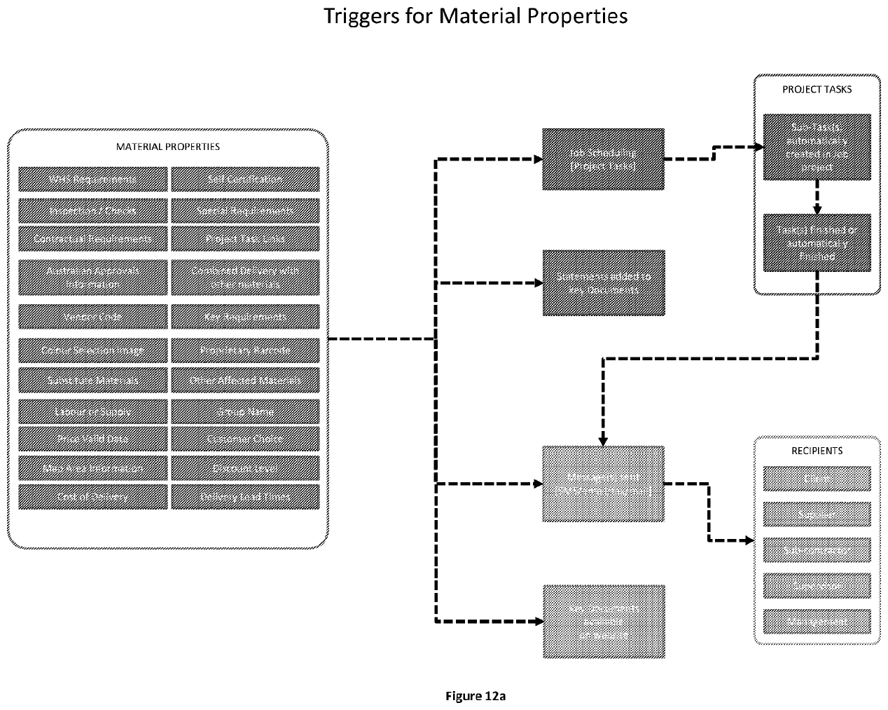

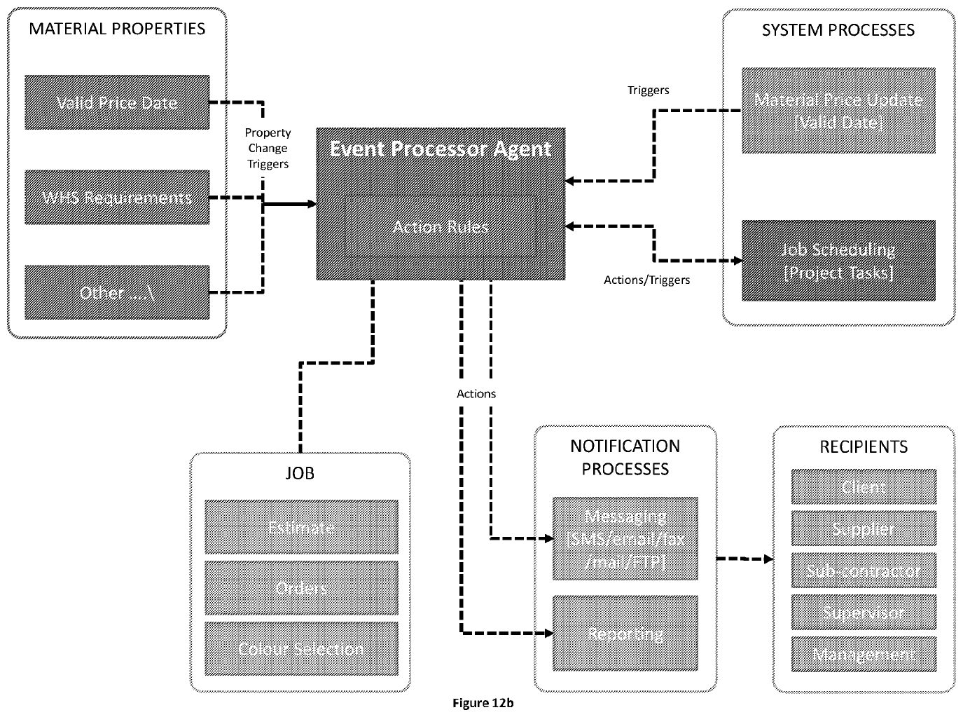

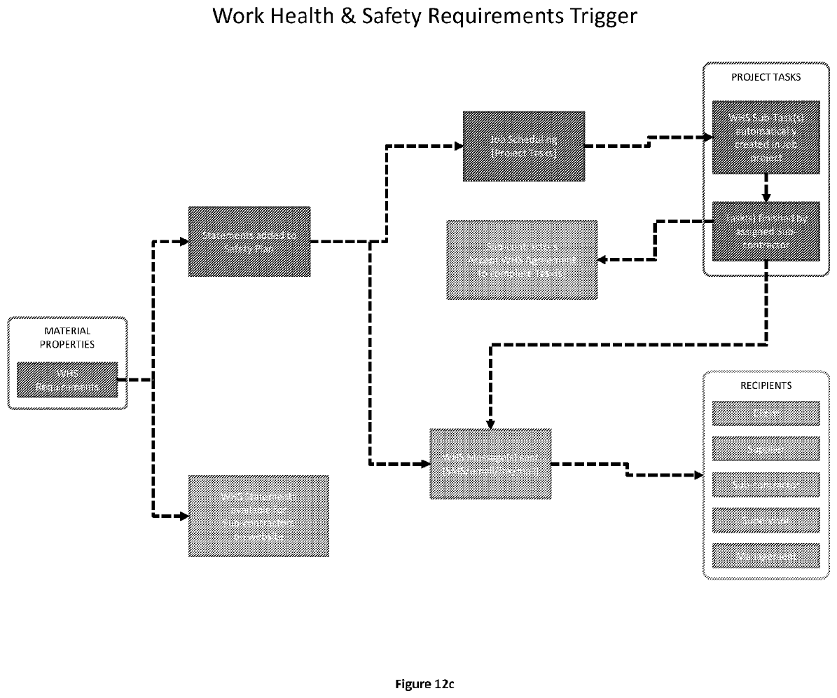

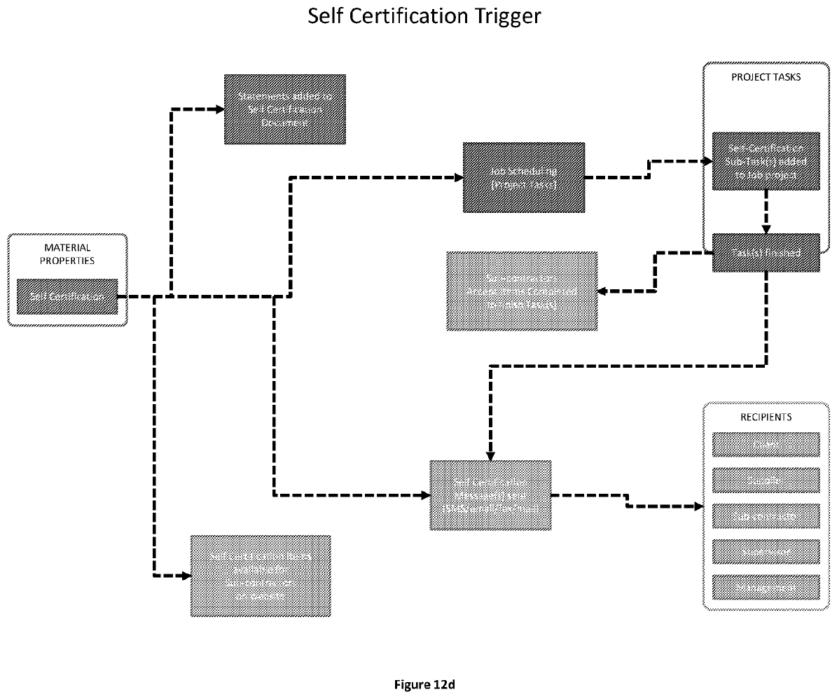

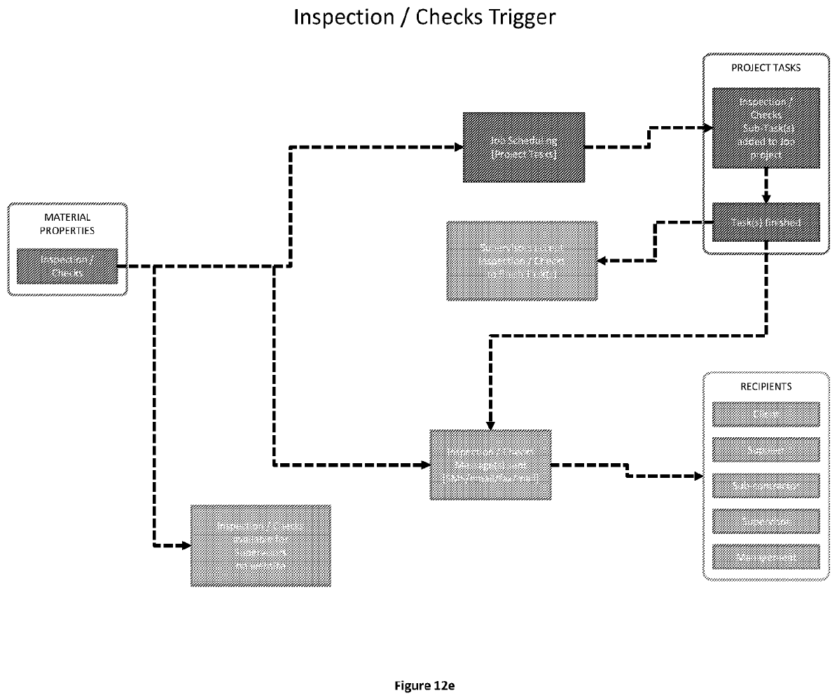

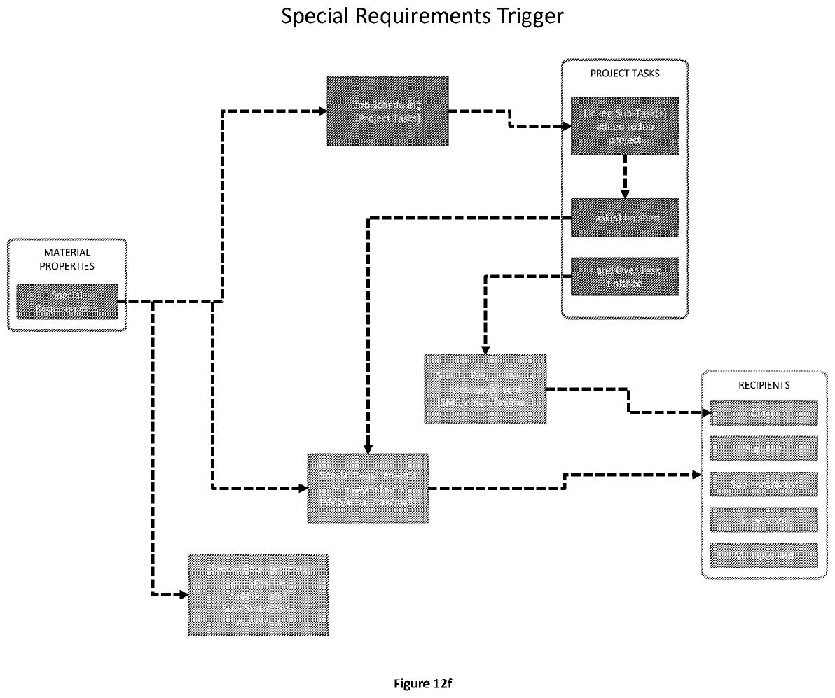

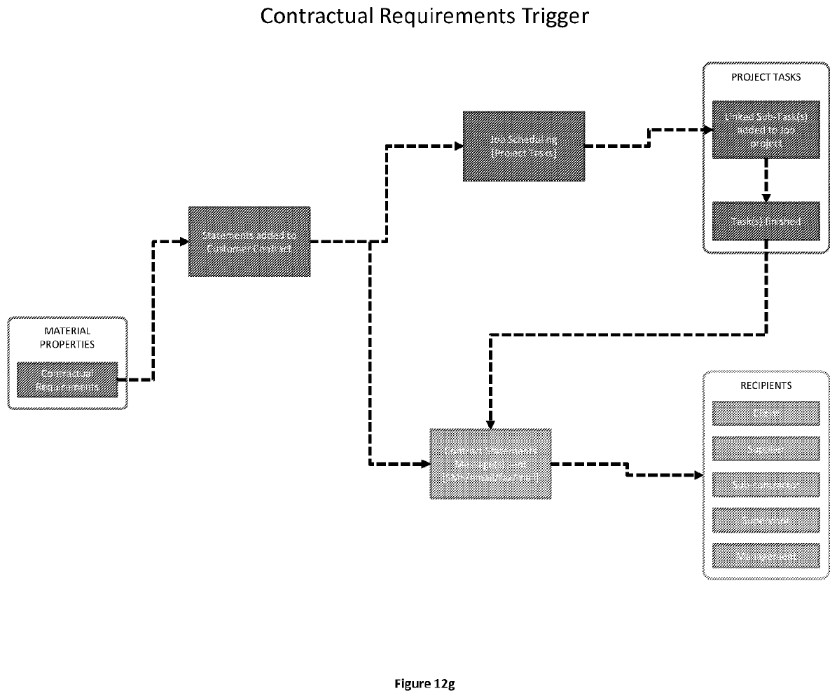

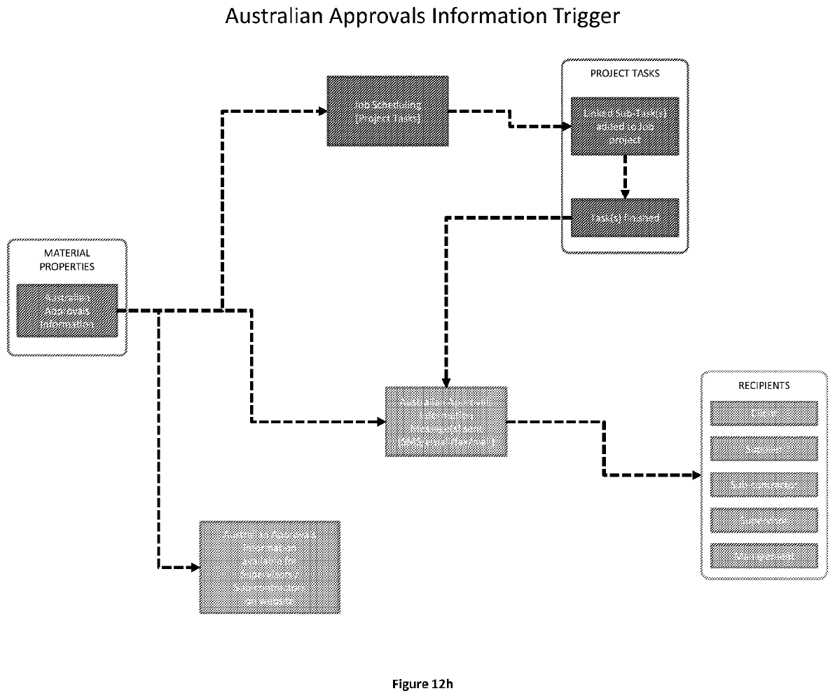

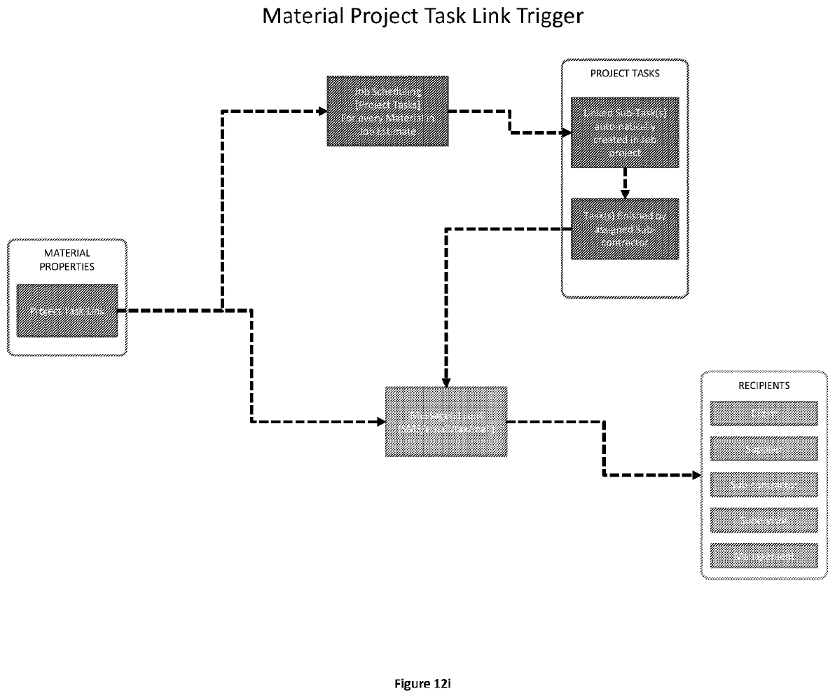

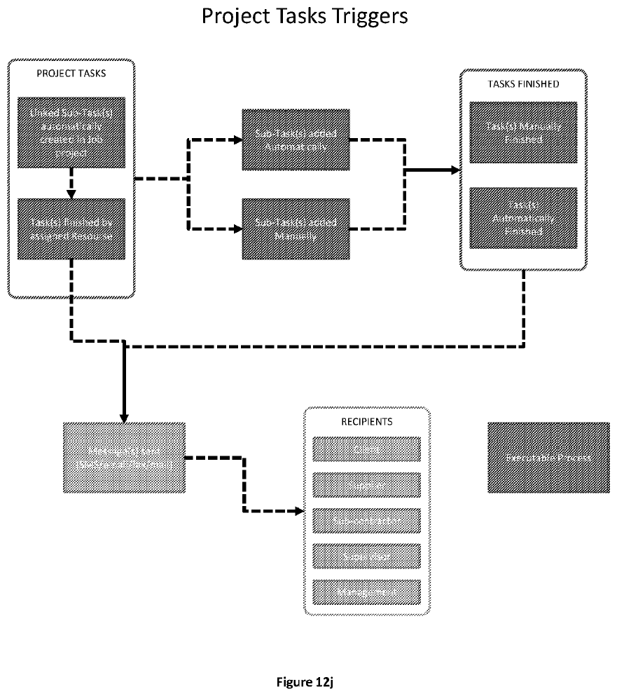

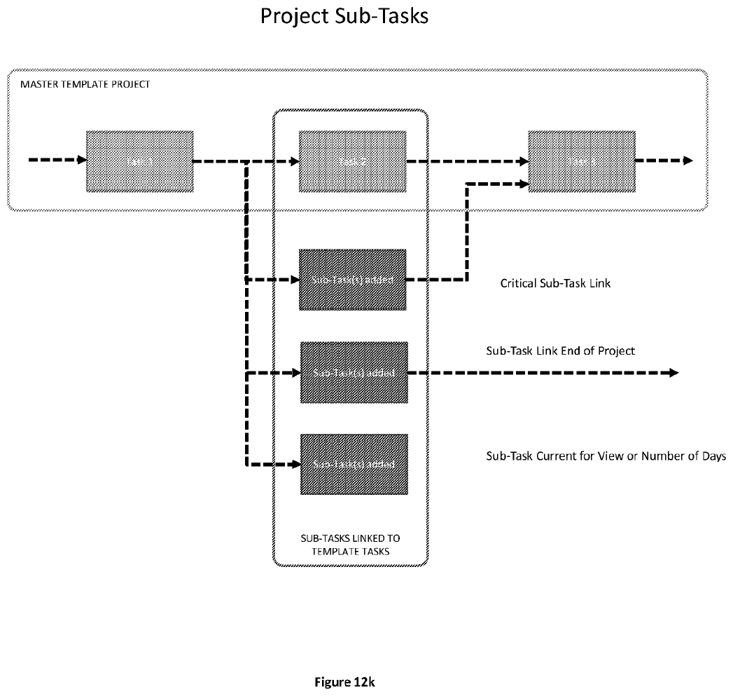

FIG. 12a-12k are block diagrams showing the material properties used in estimating and the various actions rules and triggers applied.

### EXAMPLE

At Block 10-116, a sales estimate is provided for the construction project using computer aided design (CAD) data from Blocks 10-201, 10-217 and location and/or specification data from Block 10-211.

The overlay design rules from document library 10-125 are actioned by the machine learning artificial intelligence to ensure that the sales estimate remains current when changes to the project design are made. The system 100 is capable of learning by effectively memorizing prior solutions for previous projects and incorporating them into project management functions including estimating and purchasing for a current project. In this manner, the estimates, scheduling, management and administration of the project can be amended without human intervention.

The foregoing fully digitized and automated system 100 provides for a reduction in management of up to 95% and a reduction in office staff of up to 75% when administering building construction projects. Furthermore, the errors associated with project management are substantially reduced.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. An automated building construction project management system including:
a data receiver for receiving project data relating to a project;
a processor for processing the received project data;
an action generator for automatically generating actions based upon the processed data; and
a quality assurance system for multilevel information distribution.

2. An automated building construction project management system as claimed in claim 1, wherein the processor includes a multitude of processing modules relating to various aspects of the project, thereby enabling automatically generated actions that represent a clear overall picture of the project.

3. An automated building construction project management system as claimed in claim 1, wherein the processor includes artificial intelligence, the processor overlaying design rules actioned by the artificial intelligence.

4. An automated building construction project management system as claimed in claim 3, wherein the artificial intelligence includes machine learning capable of learning by effectively memorizing prior solutions for previous projects and incorporating them into project management functions for the project.

5. An automated building construction project management system as claimed in claim 1, wherein estimates, scheduling, management and/or administration of the project can be automatically amended without human intervention.

6. An automated building construction project management system as claimed in claim 1, configured to generate a cost estimate using computer aided design (CAD) data for the project, wherein the cost estimate is compared with a project schedule to identify missing tasks in the project schedule.

7. An automated building construction project management system as claimed in claim 6, wherein the generated cost estimate is further determined using any one or more of location, local statutory or town planning requirements, or specification data.

8. An automated building construction project management system as claimed in claim 1, wherein the system is configured to generate a project schedule for the project, wherein the project schedule is compared to a cost estimate to identify missing labour and materials in the cost estimate.

9. An automated building construction project management system as claimed in claim 8, further configured to administer the project schedule using critical path algorithms, task durations and/or predecessor task links.

10. An automated building construction project management system as claimed in claim 1, configured to determine tasks due now, tasks which are overdue, task scheduled dates compared with the original baseline schedule dates and/or the number of days the project remains unfinished.

11. An automated building construction project management system as claimed in claim 1, configured to communicate with customers, suppliers and/or consultants.

12. An automated building construction project management system as claimed in claim 1, configured to generate site-specific preliminary orders for the project using identify specification and/or location data.

13. An automated building construction project management system as claimed in claim 6, configured to create contract documents using CRM data and the generated cost estimate.

14. An automated building construction project management system as claimed in claim 1, wherein the processor includes integrated processing modules including one or more of: a customer management module; an estimating and ordering module; a contract and compliance module; a project management module; a bookkeeping and WIP (Work in Progress) module and a business reports module.

15. An automated building construction project management method involving:
receiving project data relating to a project;
processing the received project data;
automatically generating actions based upon the processed data; and
performing quality assurance through multilevel information distribution.

16. An automated building construction project management method as claimed in claim 15, involving automatically generating actions that represent a clear overall picture of the project.

17. An automated building construction project management method as claimed in claim 15, involving overlaying design rules actioned by artificial intelligence.

18. An automated building construction project management method as claimed in claim 15, involving generating a cost estimate using computer aided design (CAD) data for the project, wherein the cost estimate is compared with a project schedule to identify missing tasks in the project schedule.

19. An automated building construction project management method as claimed in claim 15, involving automatically amending, without human intervention, estimates, scheduling, management and/or administration of the project.

20. An automated building construction project management method as claimed in claim 15, involving determining tasks due now, tasks which are overdue, task scheduled dates compared with the original baseline schedule dates and/or the number of days the project remains unfinished.
